(19) United States
(12) Patent Application Publication
(10) Pub. No.: US 2025/0319583 A1
(43) Pub. Date: Oct. 16, 2025

(54) HYBRID MANUFACTURING TABLE

(71) Applicant: Haddy, Inc., St. Petersburg, FL (US)

(72) Inventors: Kyle Rowe, St. Petersburg, FL (US); Dylan Hoskins, St. Petersburg, FL (US); John Rogers, St. Petersburg, FL (US); Jonathan Miller, St. Petersburg, FL (US); Numa Pailhol, St. Petersburg, FL (US)

(21) Appl. No.: 19/172,101

(22) Filed: Apr. 7, 2025

Related U.S. Application Data
(60) Provisional application No. 63/632,038, filed on Apr. 10, 2024.

(51) Int. Cl. B25H 1/14

(52) U.S. Cl. CPC B25H 1/14

(57) ABSTRACT

A hybrid manufacturing table for three-dimensional (3D) printed workpieces includes a first table component and a second table component. The first table component is formed to include a plurality of slots extending therethrough. The second table component is positioned below the first table component and includes a plurality of rungs that extend upwardly into and through the plurality of slots. The table changes between different configuration to allow for 3D printing and machining of workpieces thereon.

### CROSS REFERENCE TO RELATED APPLICATIONS

This application claims priority to and the benefit of U.S. Provisional Patent Application No. 63/632,038, filed 10 Apr. 2024, the disclosure of which is now expressly incorporated herein by reference.

### FIELD OF THE DISCLOSURE

The present disclosure relates generally to manufacturing tables, and more specifically to hybrid manufacturing tables for use in machining workpieces and 3D printing workpieces.

### BACKGROUND

Generally, different manufacturing tables are used for machining of workpieces and 3D printing of workpieces. For example, in machining, fixturing surfaces may be included on the table to allow for sturdy and repeatable fixturing of workpieces to the table prior to and during machining. As another example, in additive manufacturing, print surfaces may be included on the table to aid in adhesion of the workpiece to the print surface. These different tables may be costly and may take up significant space in a workshop. Therefore, there exists a need for improved manufacturing tables.

### SUMMARY

The present disclosure may comprise one or more of the following features and combinations thereof.

A hybrid manufacturing table for three-dimensional (3D) printed workpieces map comprise a first table component and a second table component. The first table component may have a top surface and a bottom surface opposite the top surface. The first table component may be formed to include a plurality of slots extending therethrough and spaced apart from one another along a width of the first table component. The second table component may be positioned below the first table component. The second table component may include a base and a plurality of rungs extending upwardly from the base and spaced apart from one another along a width of the second table component.

In some embodiments, the hybrid manufacturing table may be configured to change between (i) a machining configuration in which the second table component may be positioned below the first table component in a lowered position so that a top surface of each of the plurality of rungs may be below the top surface of the first table component, (ii) a printing configuration in which the second table component may be moved to a level position due to upward movement of the plurality of rungs of the second table component toward the first table component to cause each of the plurality of rungs to extend into a corresponding one of the plurality of slots so that the top surface of each of the plurality of rungs may be flush with the top surface of the first table component, and (iii) a releasing configuration in which the second table component may be moved to a raised position due to upward movement of the plurality of rungs of the second table component to cause each of the plurality of rungs to extend through a corresponding one of the plurality of slots so that the top surface of each of the plurality of rungs may be above the top surface of the first table component.

In some embodiments, in the printing configuration, the top surface of each of the plurality of rungs may cooperate with the top surface of the first table component to form a continuous flat surface to support a workpiece thereon during 3D printing of the workpiece. The hybrid manufacturing table may be further configured to change to a positioning configuration in which the second table component may move to a semi-raised position due to upward movement of one of the plurality of rungs of the second table component to cause the one of the plurality of rungs to extend through a corresponding one of the plurality of slots so that the top surface of the one of the plurality of rungs may be above the top surface of the first table component and the top surface of each of the remaining plurality of rungs may be flush with the top surface of the first table component.

In some embodiments, the top surface of the first table component may be formed to include a plurality of holes extending therethrough. The hybrid manufacturing table may further comprise a print panel configured to be arranged on top of the top table component while the hybrid manufacturing table is in the printing configuration. The hybrid manufacturing table may further comprise a vacuum pump fluidly coupled with the plurality of holes of the first table component and configured to apply a suction force to the print panel to hold the print panel in a stationary position on the first table component.

In some embodiments, the hybrid manufacturing table may further comprise a temperature control system including a heater configured to heat the top surface of the first table component and/or the top surface of each of the plurality of rungs of the second table component. The heater may be configured to heat the first table component and the second table component independently of one another. The heater may comprise solar heated water. The heater may comprise a resistive heater. The temperature control system may further include a cooler configured to cool the top surface of the first table component and/or the top surface of each of the plurality of rungs of the second table component.

According to another aspect of the present disclosure, a method of using a hybrid manufacturing table may comprise positioning a second table component below a first table component, forming a continuous flat surface of the hybrid manufacturing table by raising a plurality of rungs of the second table component relative to the first table component to cause each of the plurality of rungs to extend into a corresponding slot of the first table component so that a top surface of each of the plurality of rungs is flush with a top surface of the first table component, raising the plurality of rungs of the second table component to cause each of the plurality of rungs to extend through the corresponding slot so that the top surface of each of the plurality of rungs is above the top surface of the first table component, and lowering the second table component relative to the first table component so that the top surface of each of the plurality of rungs of the second table component is positioned below the top surface of the first table component.

In some embodiments, the method may further comprise, after the step of forming, raising one of the plurality of rungs of the second table component to cause the one of the plurality of rungs to extend through the corresponding slot so that the top surface of the one of the plurality of rungs is above the top surface of the first table component. The method may further comprise, after the step of forming, positioning a print panel on the continuous flat surface. The method may further comprise, after the step of positioning a print panel, applying a suction force to the print panel to hold the print panel in a stationary position on the first table component.

In some embodiments, the method may further comprise, after the step of forming, independently heating the top surface of the first table component and the top surface of each of the plurality of rungs of the second table component. The method may further comprise, after the step of independently heating, cooling the top surface of the first table component and the top surface of each of the plurality of rungs of the second table component. The method may further comprise, after the step of raising, continue heating the top surface of the first table component and stop heating the top surface of each of the plurality of rungs of the second table component.

In some embodiments, the method may further comprise, after the step of forming and before the step of raising, 3D printing a workpiece on the continuous flat surface. In some embodiments, the step of raising may include raising the workpiece with the plurality of rungs to release the workpiece from the first table component. The method may further comprise, after the step of lowering, coupling the workpiece to the first table component to hold the workpiece in a stationary position relative to the first table component during machining of the workpiece.

### BRIEF DESCRIPTION OF THE DRAWINGS

The detailed description particularly refers to the accompanying figures in which:

FIG. 1 is a perspective view of a hybrid manufacturing table for machining of workpieces and 3D printing of workpieces, the hybrid manufacturing table including a first table component formed to include a plurality of slots extending therethrough and a second table component positioned below the first table component;

FIG. 2 is a top view of the hybrid manufacturing table of FIG. 1 showing that each of the plurality of slots are spaced apart from one another along the first table component;

FIG. 3 is a bottom view of the hybrid manufacturing table of FIG. 1 showing that the second table component includes a plurality of rungs aligned with each of the plurality of slots of the first table component and configured to extend through the plurality of slots;

FIG. 4 is an enlarged perspective view of the hybrid manufacturing table of FIG. 1 showing the hybrid manufacturing table in a machining configuration in which the second table component is in a lowered position to cause a top surface of each of the plurality of rungs to be below a top surface of the first table component so that each of the plurality of slots are free for use to fix workpieces to the table during machining;

FIG. 5 is an enlarged perspective view of the hybrid manufacturing table of FIG. 1 in the machining configuration and supporting a workpiece thereon;

FIG. 6 is a perspective view of the hybrid manufacturing table of FIG. 1 showing the hybrid manufacturing table in a printing configuration in which the second table component is in a level position to cause the top surface of each of the plurality of rungs to be flush with the top surface of the first table component so that the table has a continuous flat surface for use during 3D printing of a workpiece;

FIG. 7 is a side view of the hybrid manufacturing table of FIG. 6 in the printing configuration showing that the top surface of each of the plurality of rungs and the top surface of the first table component cooperate to define a continuous flat surface for printing thereon;

FIG. 8 is a side view of the hybrid manufacturing table of FIG. 7 showing that the hybrid manufacturing table supports a workpiece thereon while in the printing configuration;

FIG. 9 is a side view of the hybrid manufacturing table of FIG. 1 showing the hybrid manufacturing table in a releasing configuration in which the second table component is in a raised position to cause the top surface of each of the plurality of rungs to be above the top surface of the first table component so that the workpiece supported on the continuous flat surface of the table is pushed upwardly to be released from the continuous flat surface;

FIG. 10 is a side view of the hybrid manufacturing table of FIG. 9 showing that the hybrid manufacturing table lifts the workpiece supported thereon via the plurality of rungs while in the releasing configuration;

FIG. 11 is a perspective view of the hybrid manufacturing table of FIG. 1 in a positioning configuration in which the second table component is in a semi-raised position to cause the top surface of one of the plurality of rungs to be above the top surface of the first table component and the top surface of the other plurality of rungs to be flush with the top surface of the first table component so that a workpiece can be positioned on the table by the one of the plurality of rungs;

FIG. 12 is a perspective view of another embodiment of a hybrid manufacturing table showing that the hybrid manufacturing table includes a print panel positioned on a top surface of a first table component to allow for different polymer materials to be used during the printing process of a workpiece;

FIG. 13 is a perspective view of the hybrid manufacturing table of FIG. 12 with the print panel removed showing that the top surface of the first table component is formed to include a plurality of holes that apply a suction force via a vacuum pump to the print panel to maintain a stationary position of the print panel on the first table component; and

FIG. 14 is an enlarged view of the hybrid manufacturing table of FIG. 13 showing the plurality of holes.

### DETAILED DESCRIPTION

A specialized hybrid manufacturing table 10 provides dual use for machining of workpieces and three-dimensional (3D) printing of workpieces on the table 10. Generally, machining and printing operations use separate tables designed for machining operations or printing operations. For example, in machining, fixturing surfaces may be included on the machining table because the fixturing surfaces allow for sturdy and repeatable fixturing of workpieces to the surface prior to and during machining. As another example, in additive manufacturing, print surfaces may be included on the printing table because the printing process may not be successful if the polymer material being printed does not have sufficient adhesion to the print surface. Further, in large scale additive manufacturing, the printed workpieces may be subject to increased stresses, which may cause the workpieces to release from the print surface, thereby leading to an unsuccessful print. Thus, the print surface remains an important quality in the printing process.

Optimal print surfaces vary based on the type of polymer material used in the printing process. Thus, it may be useful to be able to utilize a variety of print surfaces in an efficient manner in order to make printed workpieces comprising different polymer materials. Common print surfaces include metal, which may be heated or non-heated, glass, which may be heated or non-heated, and various polymers, such as acrylonitrile butadiene styrene (ABS), polyetherimide (PEI), and thermoplastic polyurethane (TPU).

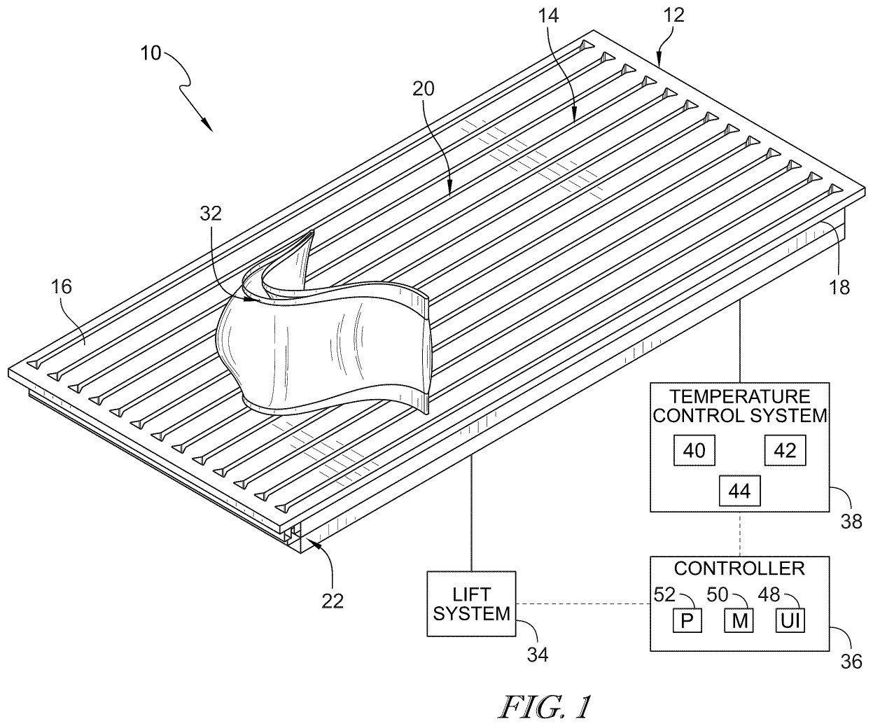

The hybrid manufacturing table 10 of the present disclosure changes between different configurations to allow for machining of workpieces, such as the workpiece 32, and printing of workpieces, such as the workpiece 32, on the same table 10. The hybrid manufacturing table 10 includes a first table component 12 and a second table component 14 coupled to the first table component 12, as shown in FIGS. 1-3. In some embodiments, the first table component 12 and the second table component 14 are made of the same metal material. In some embodiments, the first table component 12 and the second table component 14 are made of similar metal materials.

The material of each of the first table component 12 and the second table component 14 has a high stiffness compared to the materials being machined using the table 10 and/or the polymer material being printed on the table 10 such that deformation of the table components 12, 14 during fixturing and printing is minimized. The material of each of the first table component 12 and the second table component 14 has a hardness value higher than that of the polymer material being printed on the table 10, which decreases the amount of wear and tear on the table 10 (for example, scratching of the table 10 by the printed workpiece 32). The material of each of the first table component 12 and the second table component 14 allows for resurfacing of the table 10 with the same or different material if the top surface no longer meets the desired standard (for example, if the top surface is no longer flat).

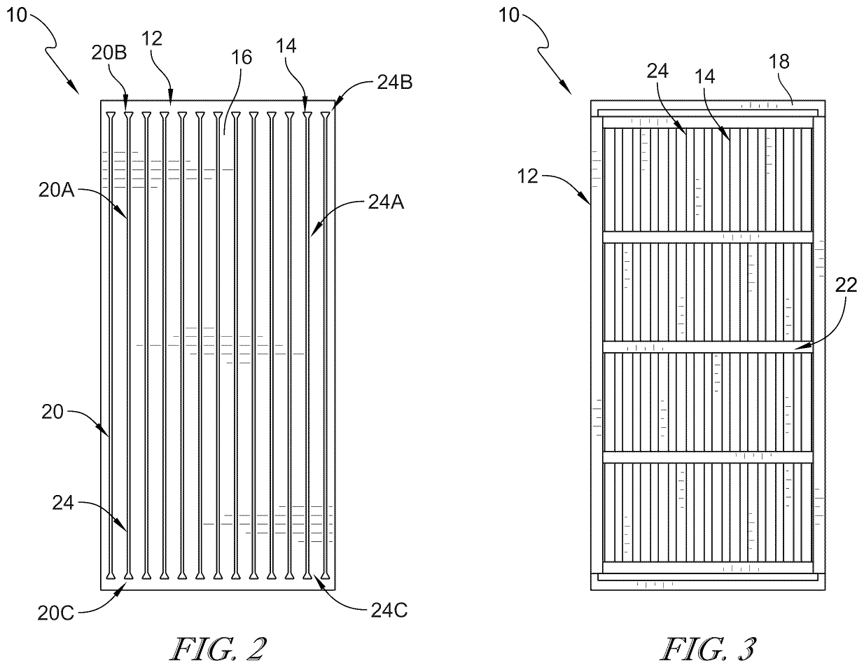

The first table component 12 includes a top surface 16 and a bottom surface 18 opposite the top surface 16, as shown in FIGS. 1 and 2. The first table component 12 is formed to include a plurality of slots 20 extending through the first table component 12. The plurality of slots 20 illustratively extends entirely between and through the top surface 16 and the bottom surface 18 of the table 10. Each of the plurality of slots 20 are spaced apart from one another along a width of the first table component 12. Illustratively, the top surface 16 does not provide a continuous flat surface due to the plurality of slots 20.

The second table component 14 is coupled with the first table component 12, as shown in FIGS. 1 and 7. The second table component 14 includes a base 22 and a plurality of rungs 24 extending upwardly from the base 22. Each of the plurality of rungs 24 are spaced apart from one another along a width of the second table component 14. Each of the plurality of rungs 24 are aligned with a corresponding one of the plurality of slots 20.

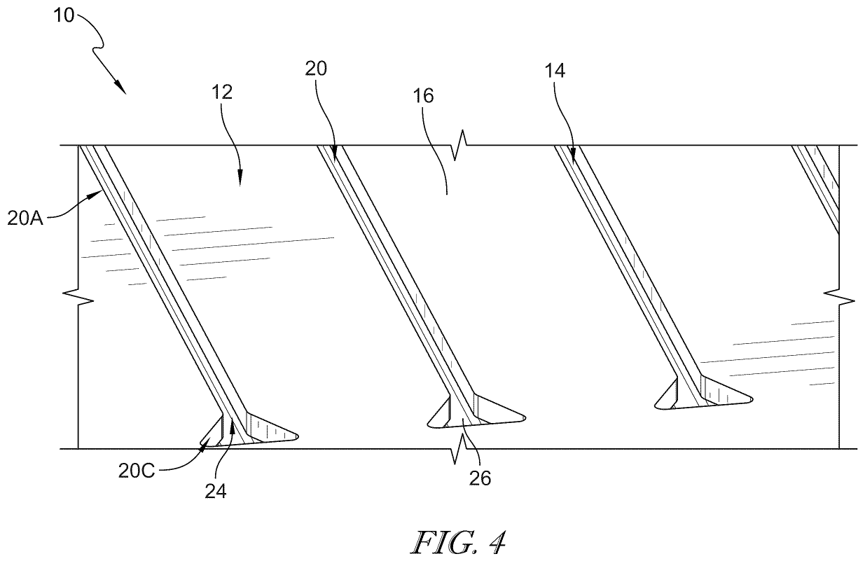

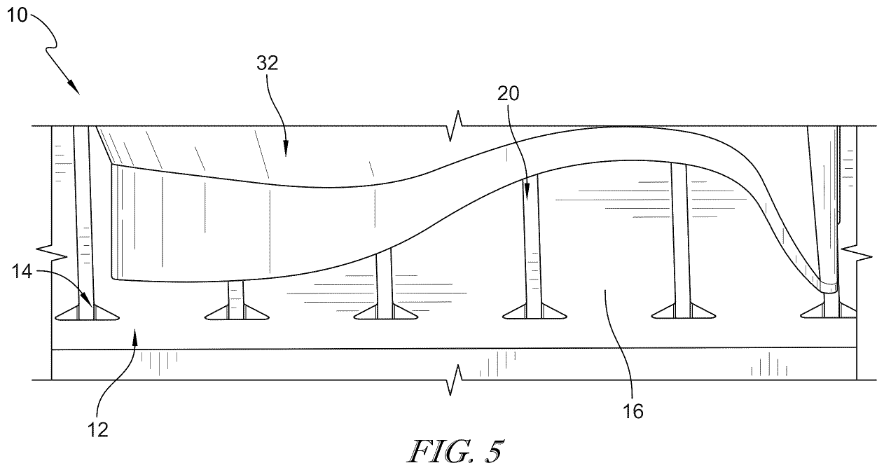

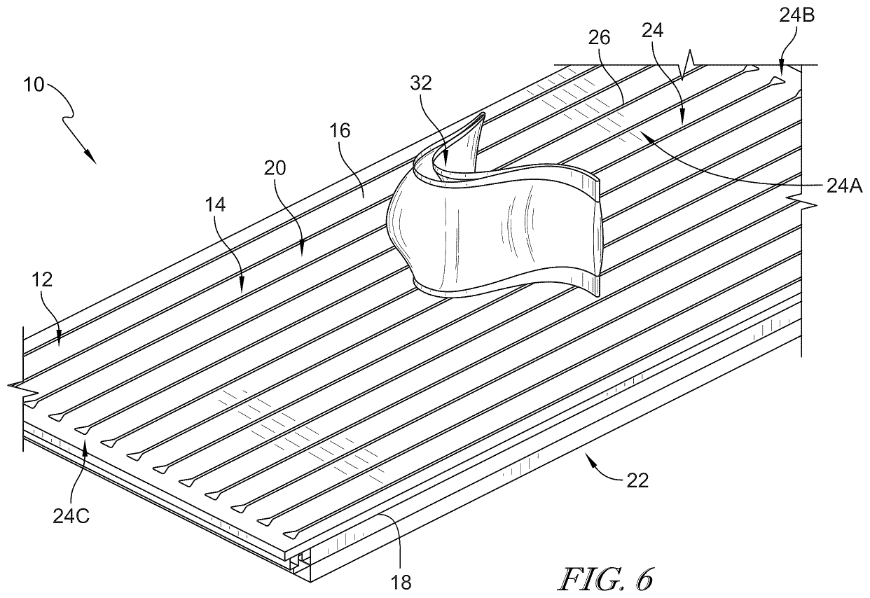

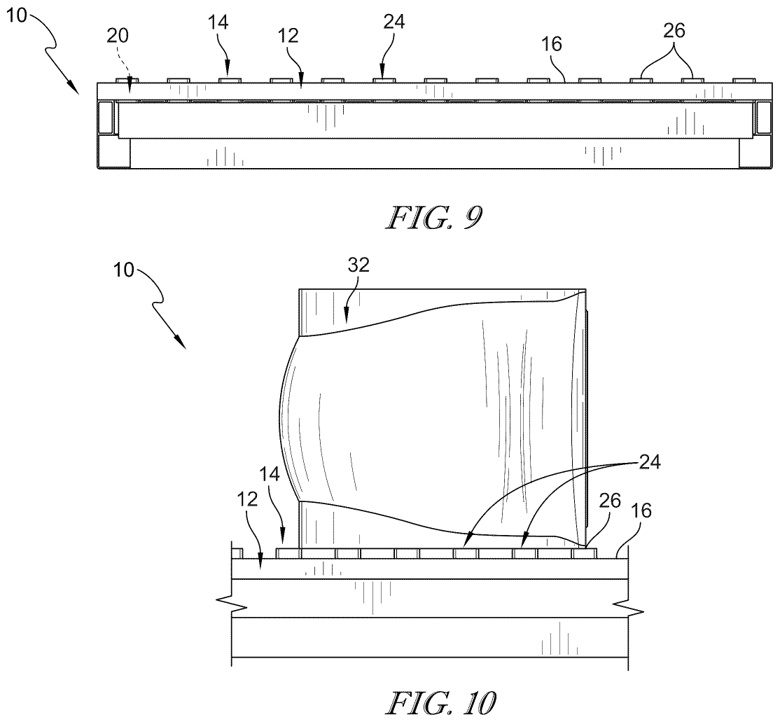

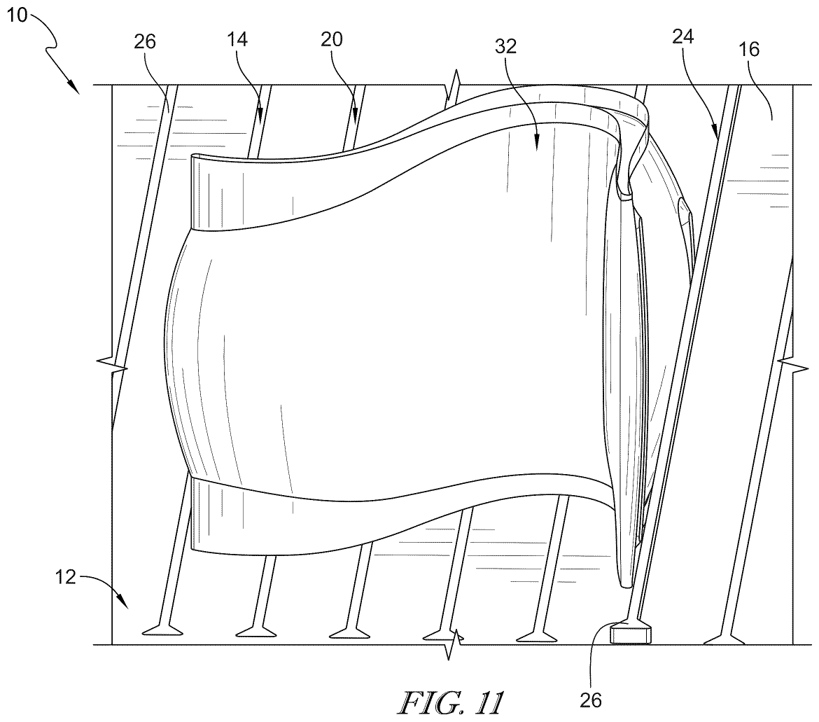

The hybrid manufacturing table 10 is configured to change between a machining configuration, as shown in FIGS. 4 and 5, a printing configuration, as shown in FIGS. 6-8, and a releasing configuration, as shown in FIGS. 9 and 10. In the machining configuration, the second table component 14 is positioned below the first table component 12 in a lowered position. In the lowered position of the second table component 14, a top surface 26 of each of the plurality of rungs 24 is below the top surface 16 of the first table component 12. In the machining configuration, the table components 12, 14 do not define a continuous flat surface. Each of the plurality of slots 20 is free to receive objects therein, such as nuts or bolts, to secure workpieces to the table 10 for machining of the workpieces. In some embodiments, the plurality of slots 20 may act as a conventional T-slot.

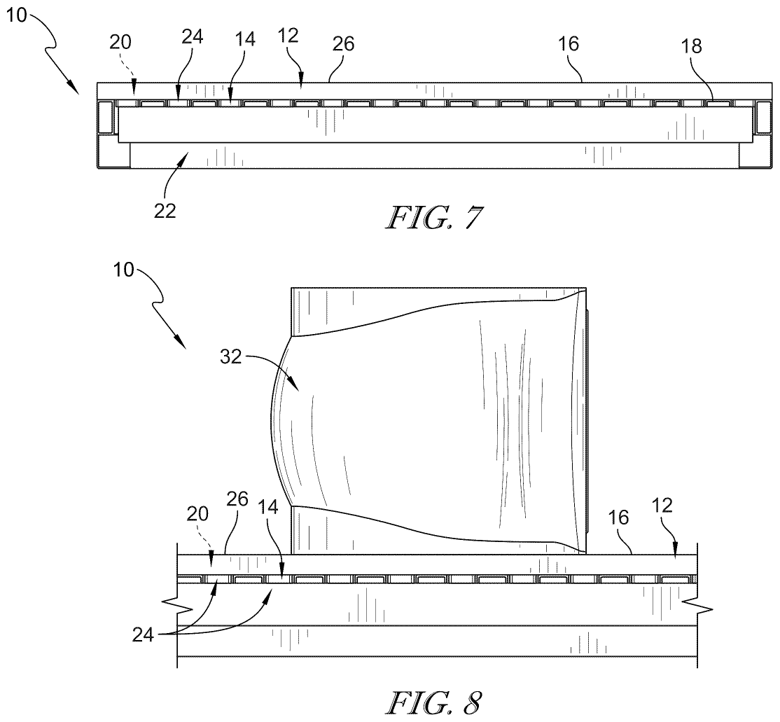

In the printing configuration, the second table component 14 moves to a level position in response to upward movement of the plurality of rungs 24 of the second table component 14 toward the first table component 12, as shown in FIG. 6. In the level position of the second table component 14, each of the plurality of rungs 24 extends into a corresponding one of the plurality of slots 20 so that the top surface 26 of each of the plurality of rungs 24 is flush with the top surface 16 of the first table component 12. In the printing configuration of the table 10, the table components 12, 14 cooperate to define a continuous flat surface, as shown in FIGS. 7 and 8. The continuous flat surface allows for 3D printing on the continuous flat surface. The plurality of rungs 24 each have a generally similar shape and size that match the shape and size of the plurality of slots 20 so that the continuous flat surface is formed.

Each of the plurality of slots 20 is formed to define a main portion 20A, a first end portion 20B extending from the main portion 20A, and a second end portion 20C extending from the main portion 20A opposite the first end portion 20B, as shown in FIGS. 2 and 4. Each of the first end portion 20B and the second end portion 20C extend outwardly from the main portion 20A to form a dovetail shape. A width of each of the first end portion 20B and the second end portion 20C increases as the end portion 20B, 20C extends away from the main portion 20A. The width of each of the first end portion 20B and the second end portion 20C is greater than a width of the main portion 20A.

Each of the plurality of rungs 24 is formed to include a main portion 24A, a first end portion 24B coupled to the main portion 24A, and a second end portion 24C coupled to the main portion 24A opposite the first end portion 24B as shown in FIGS. 2 and 6. Each of the first end portion 24B and the second end portion 24C extend outwardly from the main portion 24A to form a dovetail shape. A width of each of the first end portion 24B and the second end portion 24C increases as the end portion 24B, 24C extends away from the main portion 24A. The width of each of the first end portion 24B and the second end portion 24C is greater than a width of the main portion 24A.

In this way, the plurality of rungs 24 substantially match the shape and size of the plurality of slots 20. The main portion 24A of each of the plurality of rungs 24 is received in a corresponding main portion 20A of one of the plurality of slots. The first end portion 24B of each of the plurality of rungs 24 is received in a corresponding first end portion 20B of one of the plurality of slots, and the second end portion 24C of each of the plurality of rungs 24 is received in a corresponding second end portion 20C of one of the plurality of slots.

In the releasing configuration of the table 10, as shown in FIGS. 9 and 10, the second table component 14 moves to a raised position in response to upward movement of the plurality of rungs 24 of the second table component 14. The upward movement of the plurality of rungs 24 causes each of the plurality of rungs 24 to extend through and out of a corresponding one of the plurality of slots 20 so that the top surface 26 of each of the plurality of rungs 24 is above the top surface 16 of the first table component 12. In the releasing configuration, the table components 12, 14 do not define a continuous flat surface.

The releasing configuration of the table 10 may be used to aid in separation of the 3D printed workpiece 32 from the table 10, as shown in FIG. 10. For example, while in the printing configuration, the workpiece 32 may be 3D printed, and the workpiece 32 may stick to the continuous flat surface of the table 10. To help separate the workpiece 32 from the table 10, the second table component 14 may be moved to the raised position to help separate the workpiece 32 from the top surface 16 of the first table component 12. In doing so, the workpiece 32 will remain supported by the plurality of rungs 24, which allows for safe removal of the workpiece 32 from the table 10 with decreased risk of damaging the workpiece 32. In addition to the separation benefit of the releasing configuration of the table 10, moving the second table component 14 to the raised position also helps to cool the workpiece 32 as air may flow between each of the plurality of rungs 24 underneath the workpiece 32.

To help separate the 3D printed workpiece 32 from the table 10, the table 10 may also be changed to the machining configuration. The plurality of rungs 24 may move downwardly so that the second table component 14 moves to the lowered position. In doing so, the workpiece 32 is separated from the top surface 26 of each of the plurality of rungs 24. The workpiece 32 will remain supported by the top surface 16 of the first table component 12, which allows for safe removal of the workpiece 32 from the table 10 with decreased risk of damaging the workpiece 32. In addition to the separation benefit of the machining configuration of the table 10, moving the second table component 14 to the lowered position also helps to cool the workpiece 32 as air may flow into each of the plurality of slots 20 underneath the workpiece 32.

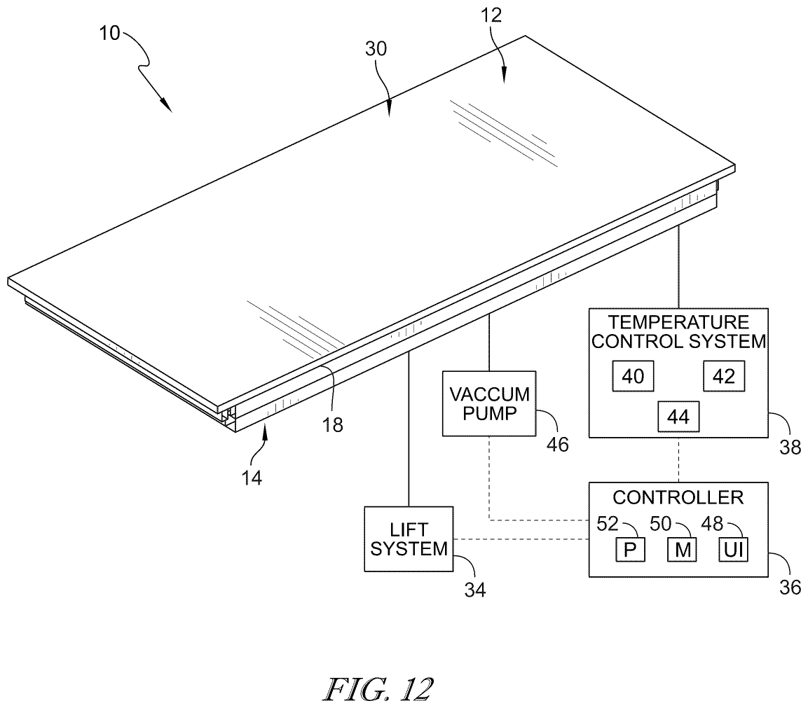

The second table component 14 may move between the lowered position, the level position, and the raised position by a lift system 34 as shown in FIGS. 1 and 12. The lift system 34 may comprise a pneumatic system, a hydraulic system, an electric actuator, a screw jack, or other mechanical systems, such as a camshaft. In some embodiments, an entirety of the second table component 14 is moved by the lift system 34. In some embodiments, the plurality of rungs 24 is moved by the lift system 34.

In some embodiments, the hybrid manufacturing table 10 further includes a controller 36, as shown in FIGS. 1 and 12. The controller 36 is in communication with the lift system 34 to selectively direct the lift system 34 to adjust the position of the second table component 14. In some embodiments, the controller 36 may include a user interface 48. For example, the user may press a button on the user interface 48 corresponding to the level position of the second table component 14, and the controller 36 may direct the lift system 34 to adjust the second table component 14 to the level position. In some embodiments, the controller 36 includes a memory 50 with instructions stored therein and a processor 52 connected with the memory 50 and configured to perform the instructions.

In some embodiments, the hybrid manufacturing table 10 may also be changed to a positioning configuration, as shown in FIG. 11. In the positioning configuration, the second table component 14 is moved to a semi-raised position in response to upward movement of one of the plurality of rungs 24. The one of the plurality of rungs 24 extends through and out of a corresponding one of the plurality of slots 20 so that the top surface 26 of the one of the plurality of rungs 24 is above the top surface 16 of the first table component 12. The top surface 26 of each of the remaining plurality of rungs 24 is flush with the top surface 16 of the first table component 12 or below the top surface 16 of the first table component 12.

The positioning configuration of the table 10 may be useful during machining of workpieces 32. For example, the one of the plurality of rungs 24 may be used as a positional reference for machining and/or may be used for clamping. The workpiece 32 may abut the one of the plurality of rungs 24, as shown in FIG. 11, to minimize movement of the workpiece 32 on the first table component 12.

In some embodiments, each of the plurality of rungs 24 is individually controlled via the lift system 34. In some embodiments, the plurality of rungs 24 are controlled together.

In some embodiments, the table 10 may include a temperature control system 38 configured to selectively adjust a temperature of the top surface 16 of the first table component 12 and/or the top surface 26 of each of the plurality of rungs 24, as shown in FIGS. 1 and 12. In some embodiments, the temperature control system 38 includes a heater 40. The heater 40 is configured to increase the temperature of the top surface 16 of the first table component 12 and/or each of the plurality of rungs 24. In one example, the top surface 26 of each of the plurality of rungs 24 is heated.

The heater 40 is configured to increase the temperature of the top surface 16 of the first table component 12 independently of the top surface 26 of each of the plurality of rungs 24 in the illustrative embodiment. The temperature control system 38 may be connected with the controller 36, as shown in FIG. 1, such that the controller 36 selectively directs the operation of the heater 40. For example, the user may press a button on the user interface 48 corresponding to an on/off operation of the heater 40 and/or an optimal temperature of the top surface 16 of the first table component 12 and/or the top surface 26 of each of the plurality of rungs 24. The controller 36 may direct the heater 40 to heat the surfaces 16, 26 based on the user's instruction.

Temperature control of the surfaces 16, 26 allows for the use of different polymer materials with the table 10. For example, certain polymer materials may work well with a heated print surface 16, 26 for adhesion of the polymer materials to the surface 16, 26 during the printing process. The heater 40, thus, allows the table 10 to be used with different polymer materials as the temperature of the surfaces 16, 26 may be adjusted depending on the type of polymer materials used. The heater 40 may comprise solar heated water, a resistive heater, or any other suitable heating mechanisms.

The temperature control system 38 may include passages formed in the first table component 12 and/or the plurality of rungs 24 to direct fluid therethrough. The heater 40 may include heated fluid that is moved through the passages.

In some embodiments, the temperature control system 38 includes a cooler 44, as shown in FIGS. 1 and 12. The cooler 44 is configured to decrease the temperature of the top surface 16 of the first table component 12 and/or the top surface 26 of each of the plurality of rungs 24. The cooler 44 is configured to decrease the temperature of the top surface 16 of the first table component 12 independently of the top surface 26 of each of the plurality of rungs 24 in the illustrative embodiment.

Cooling the surfaces 16, 26 helps to solidify the polymer materials after the workpiece 32 has been printed and cool the workpiece 32. Cooling the surfaces 16, 26 also helps to safely remove the printed workpiece 32 from the surfaces 16, 16 without damage to the workpiece 32 as removal of the workpiece 32 from the surfaces 16, 26 while the surfaces 16, 26 are still hot may damage the workpiece 32.

The temperature control system 38 may be connected with the controller 36 such that the controller 36 selectively directs the operation of the cooler 44. For example, the user may press a button on the user interface 48 corresponding to an on/off operation of the cooler 44 and/or an optimal temperature of the top surface 16 of the first table component 12 and/or the top surface 26 of each of the plurality of rungs 24. The controller 36 may direct the cooler 44 to cool the surfaces 16, 26. The temperature control system 38 may include passages formed in the first table component 12 and the plurality of rungs 24 to direct fluid therethrough. The cooler 44 may include cooled fluid that is moved through the passages. For example, the cooler 44 may comprise chilled water that is recirculated through the passages or is used once within the temperature control system 38 and then used as a water source for a secondary use as non-potable.

The temperature control system 38 may include sensors 42 configured to detect the temperature of the surfaces 16, 26, as shown in FIGS. 1 and 12. The sensors 42 are in communication with the controller 36. Temperature data may be stored in the memory 50 of the controller 36.

The different configurations of the table 10 help to quickly heat and/or cool the surfaces 16, 26. For example, after printing the workpiece 32, if the surfaces 16, 26 were being heated by the heater 40, the second table component 14 may move to the raised position to move the workpiece 32 upwardly with the plurality of rungs 24. After doing so, the top surface 26 of the plurality of rungs 24 may be cooled via the cooler 44 and the temperature of the top surface 16 may be maintained as the workpiece 32 is no longer contacting the top surface 16 of the first table component 12. The heating of the top surface 16 of the first table component 12 via the heater 40 may be maintained so that after the workpiece 32 is removed from the top surface 26 of the plurality of rungs 24, the second table component 14 may move to the level position and only the top surface 26 of each of the plurality of rungs 24 may need heating prior to printing another workpiece on the surfaces 16, 26. The separation of the second table component 14 from the first table component 12 while the table 10 is in the released configuration also increases the amount of surface area of the printed workpiece 32 exposed to ambient air to assist in cooling of the workpiece 32.

As another example, after printing the workpiece 32, if the surfaces 16, 26 are heated, the second table component 14 may be moved to the lowered position such that only the top surface 16 of the first table component 12 is in contact with the workpiece 32. Because the workpiece 32 is only contacting the top surface 16, only the top surface 16 may need to be cooled. The heating of the top surface 26 of the plurality of rungs 24 may be maintained so that after the workpiece 32 is removed from the top surface 16 of the first table component 12, the second table component 14 may move to the level position and only the top surface 16 of the first table component 12 may be heated prior to printing another workpiece 32. The separation of the second table component 14 from the first table component 12 while the table 10 is in the machining configuration also increases the amount of surface area of the printed workpiece 32 exposed to ambient air to assist in cooling of the workpiece 32. Thus, the overall printing process time is decreased as the cooling and/or heating time is decreased.

As previously discussed, different types of polymer materials have different optimal print surfaces. The ability to heat the surfaces 16, 26 ensures that the table 10 may be used with a wider variety of polymer materials. In some embodiments, the hybrid manufacturing table 10 includes a print panel 30, as shown in FIG. 12. The print panel 30 further expands the variety of polymer materials that may be used with the table 10. The print panel 30 is configured to be arranged on top of the first table component 12 while the hybrid manufacturing table 10 is in the printing configuration. For example, the print panel 30 may be placed on top of the top surface 16 of the first table component 12 if the particular polymer materials being printed may work well with a different print surface than that provided by the surfaces 16, 26. The print panel 30 may be comprised of acrylonitrile butadiene styrene, polyetherimide, or any other suitable materials.

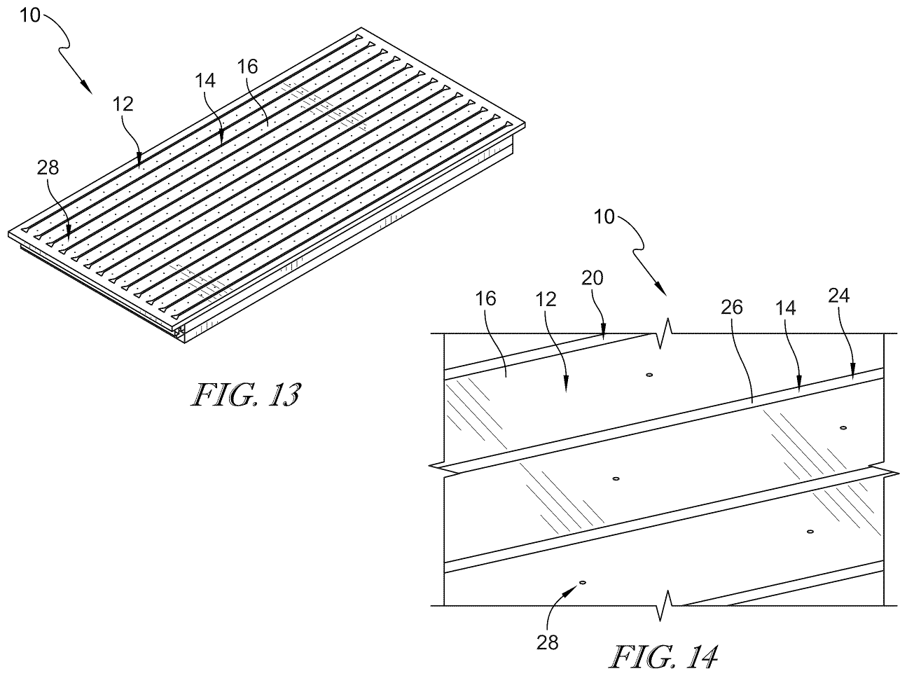

In some embodiments, the hybrid manufacturing table 10 includes a vacuum pump 46, as shown in FIG. 12. In such an embodiment, the top surface 16 of the first table component 12 is formed to include a plurality of holes 28 extending therethrough, as shown in FIGS. 13 and 14. The vacuum pump 46 is coupled with each of the plurality of holes 28 to apply a suction force to the print panel 30 to hold the print panel 30 in a stationary position on the first table component 12 during the printing process. The vacuum pump 46 may be connected with the controller 36, as shown in FIG. 12, such that the controller 36 selectively directs the operation of the vacuum pump 46. For example, the user may press a button on the user interface 48 corresponding to an on/off operation of the vacuum pump 46, and the controller 36 may direct the vacuum pump 46 to apply the suction force.

In some embodiments, the surfaces 16, 26 may be heated while the print panel 30 is in use, as long as the print panel 30 is capable of withstanding the heat. In some embodiments, the top surface 26 of each of the plurality of rungs 24 is formed to include a plurality of holes in addition to the plurality of holes 28 formed in the first table component 12. In some embodiments, the plurality of holes 28 is omitted such that the plurality of holes is only formed in the top surface 26 of each of the plurality of rungs 24.

1. A hybrid manufacturing table for three-dimensional (3D) printed workpieces comprising
a first table component having a top surface and a bottom surface opposite the top surface, the first table component formed to include a plurality of slots extending therethrough and spaced apart from one another along a width of the first table component, and
a second table component positioned below the first table component and including a base and a plurality of rungs extending upwardly from the base and spaced apart from one another along a width of the second table component,
wherein the hybrid manufacturing table is configured to change between (i) a machining configuration in which the second table component is positioned below the first table component in a lowered position so that a top surface of each of the plurality of rungs is below the top surface of the first table component, (ii) a printing configuration in which the second table component is moved to a level position due to upward movement of the plurality of rungs of the second table component toward the first table component to cause each of the plurality of rungs to extend into a corresponding one of the plurality of slots so that the top surface of each of the plurality of rungs is flush with the top surface of the first table component, and (iii) a releasing configuration in which the second table component is moved to a raised position due to upward movement of the plurality of rungs of the second table component to cause each of the plurality of rungs to extend through a corresponding one of the plurality of slots so that the top surface of each of the plurality of rungs is above the top surface of the first table component.

2. The hybrid manufacturing table of claim 1, wherein, in the printing configuration, the top surface of each of the plurality of rungs cooperates with the top surface of the first table component to form a continuous flat surface to support a workpiece thereon during 3D printing of the workpiece.

3. The hybrid manufacturing table of claim 1, wherein the hybrid manufacturing table is further configured to change to a positioning configuration in which the second table component moves to a semi-raised position due to upward movement of one of the plurality of rungs of the second table component to cause the one of the plurality of rungs to extend through a corresponding one of the plurality of slots so that the top surface of the one of the plurality of rungs is above the top surface of the first table component and the top surface of each of the remaining plurality of rungs is flush with the top surface of the first table component.

4. The hybrid manufacturing table of claim 1, wherein the top surface of the first table component is formed to include a plurality of holes extending therethrough.

5. The hybrid manufacturing table of claim 4, further comprising a print panel configured to be arranged on top of the top table component while the hybrid manufacturing table is in the printing configuration.

6. The hybrid manufacturing table of claim 5, further comprising a vacuum pump fluidly coupled with the plurality of holes of the first table component and configured to apply a suction force to the print panel to hold the print panel in a stationary position on the first table component.

7. The hybrid manufacturing table of claim 1, further comprising a temperature control system including a heater configured to heat the top surface of the first table component and/or the top surface of each of the plurality of rungs of the second table component.

8. The hybrid manufacturing table of claim 7, wherein the heater is configured to heat the first table component and the second table component independently of one another.

9. The hybrid manufacturing table of claim 7, wherein the heater comprises solar heated water.

10. The hybrid manufacturing table of claim 7, wherein the heater comprises a resistive heater.

11. The hybrid manufacturing table of claim 7, wherein the temperature control system further includes a cooler configured to cool the top surface of the first table component and/or the top surface of each of the plurality of rungs of the second table component.

12. A method of using a hybrid manufacturing table, the method comprising
positioning a second table component below a first table component,
forming a continuous flat surface of the hybrid manufacturing table by raising a plurality of rungs of the second table component relative to the first table component to cause each of the plurality of rungs to extend into a corresponding slot of the first table component so that a top surface of each of the plurality of rungs is flush with a top surface of the first table component,
raising the plurality of rungs of the second table component to cause each of the plurality of rungs to extend through the corresponding slot so that the top surface of each of the plurality of rungs is above the top surface of the first table component, and
lowering the second table component relative to the first table component so that the top surface of each of the plurality of rungs of the second table component is positioned below the top surface of the first table component.

13. The method of claim 12, further comprising, after the step of forming, raising one of the plurality of rungs of the second table component to cause the one of the plurality of rungs to extend through the corresponding slot so that the top surface of the one of the plurality of rungs is above the top surface of the first table component.

14. The method of claim 12, further comprising, after the step of forming, positioning a print panel on the continuous flat surface.

15. The method of claim 14, further comprising, after the step of positioning a print panel, applying a suction force to the print panel to hold the print panel in a stationary position on the first table component.

16. The method of claim 12, further comprising, after the step of forming, independently heating the top surface of the first table component and the top surface of each of the plurality of rungs of the second table component.

17. The method of claim 16, further comprising, after the step of independently heating, cooling the top surface of the first table component and the top surface of each of the plurality of rungs of the second table component.

18. The method of claim 16, further comprising, after the step of raising, continue heating the top surface of the first table component and stop heating the top surface of each of the plurality of rungs of the second table component.

19. The method of claim 12, further comprising, after the step of forming and before the step of raising, 3D printing a workpiece on the continuous flat surface, and wherein the step of raising includes raising the workpiece with the plurality of rungs to release the workpiece from the first table component.

20. The method of claim 19, further comprising, after the step of lowering, coupling the workpiece to the first table component to hold the workpiece in a stationary position relative to the first table component during machining of the workpiece.
